(19) United States
(12) Patent Application Publication
(10) Pub. No.: US 2009/0222541 A1
(43) Pub. Date: Sep. 3, 2009

(54) DYNAMIC SENSOR NETWORK REGISTRY

(75) Inventors: Indermohan Monga, Acton, MA (US); Garth Jenkins, Belmont, MA (US); Gautam Khera, Walpole, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: NORTEL NETWORKS LIMITED, ST. LAURENT, QC (CA)

(21) Appl. No.: 12/096,238

(22) PCT Filed: Nov. 6, 2006
(86) PCT No.: PCT/US2006/060560

§ 371 Date: Apr. 2, 2009

Related U.S. Application Data
(60) Provisional application No. 60/734,480, filed on Nov. 8, 2005.

(51) Int. Cl. G06F 15/177; G06F 15/173; H04L 9/32; G06F 17/30

(52) U.S. Cl. 709/222; 709/224; 726/12; 707/100; 707/E17.127

(57) ABSTRACT

A scalable network architecture adapted to interface with various sensor types and sensor access mechanisms while providing real-time access to sensor data for distributed applications and organizations is described. A centralized sensor network service manages the registration, capabilities, near real-time status of the sensors and their current network connections. New sensors are discovered automatically through messaging between network access nodes and the sensor registry. The registry service can be made available to distributed sensor applications and sensor middleware, and facilitates the sharing of sensors across organizations. The sensor registry is automatically updated by network software and does not require manual configuration or reconfiguration each time a sensor is added to or relocated within the network. Authentication and authorization policies can be implemented to ensure that only authorized applications can query and view the registry. The registry can be implemented for multi-vendor sensor networks and can accommodate multiple addressing schemes.

### RELATED APPLICATION

This application claims the benefit of the earlier filing date of U.S. Provisional Patent Application Ser. No. 60/734,480, filed Nov. 8, 2005, titled “Dynamic Sensor Network Resolution and Management Service,” the entirety of which is incorporated herein by reference.

### FIELD OF THE INVENTION

The invention relates generally to sensor networks. More particularly, the invention relates to a dynamic sensor network resolution and management service.

### BACKGROUND OF THE INVENTION

Advancements in computing technology have led to the production of sensors capable of observing and reporting various real-world phenomena in a time-sensitive manner. Additionally, the growth in distributed communication technology (e.g., the Internet) has led to the development of sensor networks. Sensor networks are used in numerous applications, including military, industrial and civilian applications. Generally, sensors are adapted to detect or monitor certain events or conditions. A sensor may be simple, such as a device that monitors temperature, or more complex, such as a video camera. Data generated at the sensor is transmitted in data packets over a sensor network to one or more application nodes. An application node includes one or more application software instantiations that can react to the sensor data, and may include a user interface that presents the sensor data in numerical, textual and graphical forms to users.

Sensors have been used for industrial applications and commercial applications in the past. More recently, sensors have been used for homeland security and public safety applications. Sensors are transitioning from “wired-based” or “circuit-based” implementations to packet-based networks over shared infrastructure and wireless communication networks. Examples of applications for wireless sensor networks include surveillance, inventory tracking, environmental monitoring, acoustic detection and optical detection. Wireless sensor networks are often suitable for harsh environments and wide geographical areas where unattended operation of sensors is desirable.

The ability to manage a sensor network is increasingly difficult as the number of sensors deployed increases. Moreover, sensors can be of a variety of types and can be distributed over a wide geographical area. Mobile sensors make the task more difficult as the location of mobile sensors within the network changes over time. Conventionally, application nodes communicate directly to sensors or sensor gateways. The sensor gateways do not maintain a local list of it sensors. Instead, each application maintains a statically defined list of sensors with which the application can communicate. Generally, the ability of an application to interact with other sensors is limited without knowledge of their physical addresses or the associated network access devices. Moreover, the introduction of new sensors to the network typically requires a manual reconfiguration to permit the application to communicate with such sensors.

What is needed is a means to scale, manage, access and track sensors of various types that are geographically distributed and connected to a network through various network access mechanisms. The present invention satisfies this need and provides additional advantages.

### SUMMARY OF THE INVENTION

In one aspect, the invention features a method for registering a sensor in a sensor network. A sensor is detected in communication with a network access node. Information is received from the network access node indicating a sensor type for the sensor and a number of sensors of the sensor type that communicate with the network access node. A unique registry name is automatically assigned to the sensor based on a name of the network access node, the sensor type and the number of sensors of the sensor type.

In another aspect, the invention features a method for querying sensors in a sensor network. A query for sensor data is received from an application. The query includes an application label having a context for at least one application having access to the sensor network. A network address is determined for each of a plurality of sensors associated with the application label. Sensor data are provided to the application from each of the sensors associated with the application label.

In still another aspect, the invention features a sensor registry system for management of a sensor network. The sensor registry includes a registry module configured to receive sensor information transmitted from a sensor gateway through the sensor network and to automatically generate a unique sensor name in response to the sensor information. The sensor information includes a sensor type and a network address for the sensor gateway. The sensor registry also includes a database in communication with the registry module. The database is configured to store the sensor type, the network address for the sensor gateway and sensor data most recently transmitted from the sensor gateway.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 illustrates a network configuration in which the method of the invention can be practiced according to an embodiment of the invention.

FIG. 2 illustrates the relocation of the dynamic sensor of FIG. 1 to a different local sensor network.

FIG. 3 is a flowchart representation of an embodiment of a method for naming and registering a newly-added sensor to a sensor network in accordance with the invention.

FIG. 4 is a flowchart representation of an embodiment of a method for querying sensors in a sensor network in accordance with the invention.

FIG. 5 illustrates a centralized sensor registry in accordance with the invention.

### DETAILED DESCRIPTION

In brief overview, the invention relates to a scalable network architecture adapted to interface with various sensor types and sensor access mechanisms while providing real-time access to sensor data for distributed applications and organizations. A centralized sensor network service manages the registration, capabilities and near real-time status (i.e., “heartbeat) of the sensors, and current network connections for the sensors. New sensors are discovered automatically through messaging between network access nodes and the sensor registry. The registry service automatically assigns new unique names to the new sensors. It is possible for multiple islands of sensor registries to be shared through an authentication, authorization and accounting (AAA) service. The registry service can be made available to distributed sensor applications and sensor middleware used to support distributed applications. In addition, the registry service facilitates the sharing of sensors across organizations.

Advantageously, the sensor registry is automatically updated by network software. Thus, unlike IP address registration in domain name service (DNS) processes, the sensor registry service does not require manual configuration or reconfiguration each time a sensor is added to or relocated within the network. AAA policies can be implemented to ensure that only authorized applications can query the registry and view authorized portions of the registry. The registry can be implemented for multi-vendor sensor networks and can accommodate multiple addressing schemes.

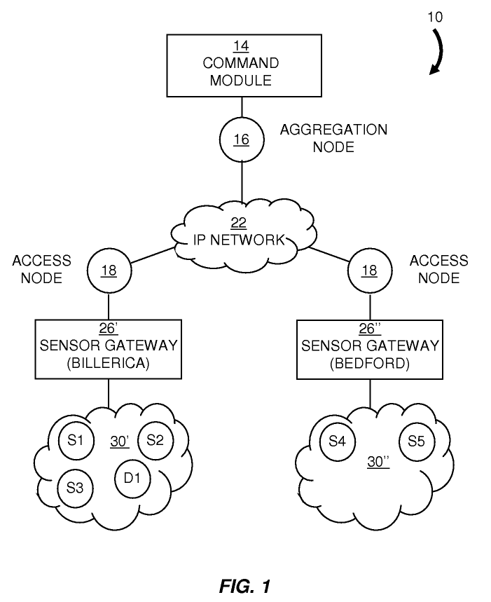

FIG. 1 shows a network configuration 10 in which the method of the invention may be practiced. A command module 14 communicates with an aggregation node 16. Network access nodes 18 (e.g., network routers) communicate with the aggregation node 16 through an intervening IP network 22 (e.g., the Internet) which may include other network nodes. Each network access node 18 communicates with one or more edge devices, shown here as sensor gateways 26′ and 26″ (generally 26). Each sensor gateway 26 bridges a local sensor network 30, such as a wireless network, to the IP network 22. For example, the wireless network can be configured for operation according to the IEEE 802.11 standard.

The illustrated network configuration 10 includes two local sensor networks 30. One local sensor network (Billerica) 30′ includes three stationary sensors S1, S2 and S3, and a dynamic (i.e., mobile) sensor D1 which is not restricted for use with a single network edge device. The second local sensor network (Bedford) 30″ includes two stationary sensors S4 and S5. The sensors S1 to S5 (generally S) can be of a variety of types. Generally, each type corresponds to a physical or environmental measurement parameter, such as temperature, sound, vibration, acceleration and pressure.

The sensor registry of the invention is instantiated at the command module 14 which includes processing and database components as described in more detail below. Although the sensor registry is “centralized” at the command module 14, the registry is implemented and maintained in a distributed manner. More specifically, the network access nodes 18 and aggregation node 16 update and maintain the dynamic components of the sensor registry. In one embodiment, the sensor registry determines that the information for one or more sensors S is no longer useful, or “stale.” The determination may be made upon the expiration of a programmable update time. To retrieve updated information, the command module 14 queries the network access nodes 18 for fresh information.

As new sensors are added to the network 10, messaging between the network access nodes 18 and the sensor registry allows for their discovery. The discovery of a new sensor occurs when the sensor starts sending data back to the aggregation point. Mechanisms defined in standards, such as IEEE 1451, can be used to gather further details about the sensor type and configuration and a new name is generated for the new sensor. Advantageously, the messaging avoids any need to modify legacy sensors and sensor gateways 26, as the network access nodes 18 act as proxies.

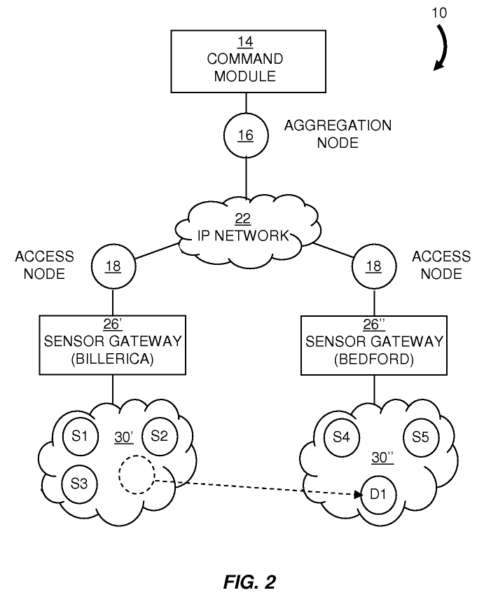

In some network configurations, one or more dynamic sensors change their location over time. FIG. 2 illustrates how the dynamic sensor D1 in FIG. 1 has relocated to the second local sensor network 30″ and now connects to the network 10 through a different sensor gateway 26″ and access node 18. Beneficially, the sensor registry can track the location of dynamic sensors and update their reachability information, i.e., information on the current network access nodes 18 used by the dynamic sensors. In addition, the zone or location variables for a sensor can be automatically updated in the sensor registry according to GPS location data provided by the sensor. If the sensor does not have GPS capability, the IP address of the associated network access node 18 can be used to determine an approximate zone for wireless/radio access.

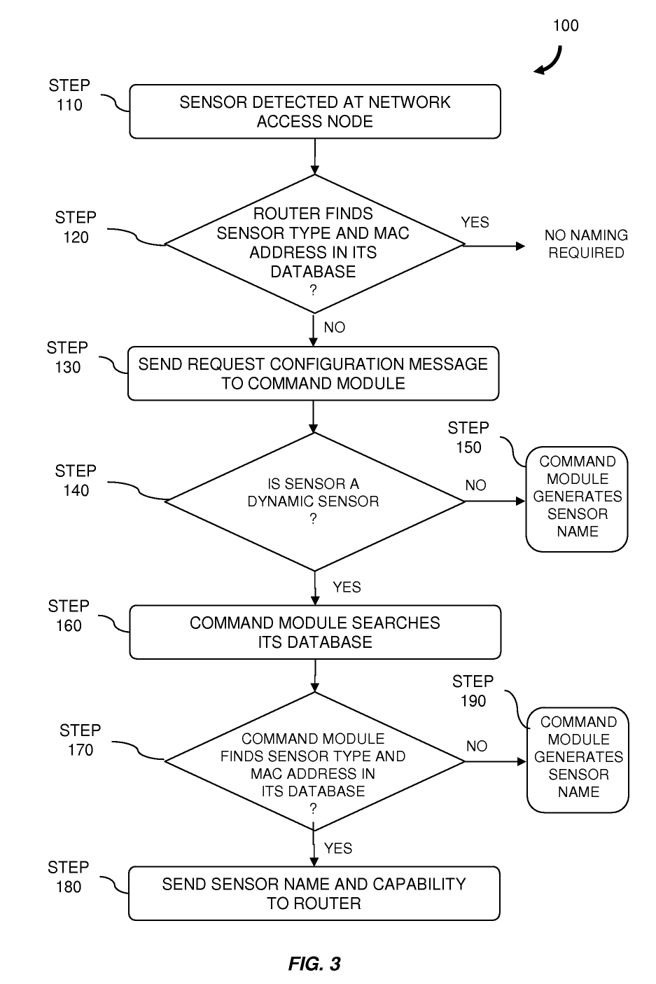

FIG. 3 is a flowchart depicting an embodiment of a method 100 for naming and registering a newly-added sensor to a sensor network in accordance with the invention. As the new sensor is first detected (step 110) at a network router (i.e., the associated network access node), the router performs a database lookup for the sensor type (e.g., capability) and the media access control (MAC) address. If it is determined (step 120) that no corresponding name is found in the database, a request configuration message is sent (step 130) to the command module. If it is determined (step 140) that the sensor is static, then the command module generates (step 150) a unique name for the sensor as described in more detail below. The command module provides the new name to the router and updates the registry database. However, if it is determined (step 140) that the sensor is dynamic (i.e., mobile), the command module searches (step 160) its database for the sensor type and MAC address. If the command module finds (step 170) the sensor type and MAC address of the dynamic sensor in its database, the sensor name and capability are sent (step 180) to the router. Alternatively, if the sensor type and MAC address are not found (step 170), the command module generates (step 190) a unique name for the dynamic sensor, provides the name to the router and updates the registry database.

Sensors names generated for static sensors are based on the type, or “capability”, of the sensor and its network edge device. In one embodiment, static sensor names are of the form

<network edge device>:capability:index

where “capability” represents the type of device measurement, such as temperature, sound, vibration, acceleration or pressure, and where index indicates a specific one of similar capability sensors at the same network edge device. Index values are maintained at the edge device.

A dynamic sensor has no “permanent” network edge device therefore the generation of dynamic sensor names is different than for static sensors. In one embodiment, dynamic sensor names are of the form

<mobile>: capability:index

where the index values are maintained at the command module and each index value indicates a specific one of similar capability dynamic sensors.

According to the above naming procedure and with reference to FIG. 1 for an example of naming according to the invention, the names of the static sensors are
S1=billerica.ma.us:temperature:1
S2=billerica.ma.us:accelerometer:1
S3=billerica.ma.us:temperature:2
S4=bedford.ma.us:temperature:1
S5=bedford.ma.us:accelerometer:1

The dynamic sensor D1 which is not constrained to a single network edge device 26 is named
D1=mobile:rfid:4
   because the command module 14 has previously registered and stored information for three other mobile radio frequency identification (RFID) devices in the sensor registry database.

In normal IP network addressing, having a name for a device on a network is not sufficient to send data to that device. Generally, a DNS server is required to resolve an IP address associated with the device name. Although the method of the invention provides a similar service by resolving the sensor name with an IP address, substantially more functionality is provided by the sensor registry service. Sensors are typically not addressed using IP addresses. Instead, a flexible address translation function associates sensor names (or application labels, as described below) and the respective IP addresses. Instead of a single IP address, the sensor registry provides the addressing path for communicating with the sensor which may include, for example, the IP network access node, sensor gateway identification (ID), wireless mesh end-device ID, and the analog or digital channel number for the sensor.

The sensor registry optionally provides “protection” of sensors by implementing authentication, authorization and accounting (AAA) policies for applications accessing the registry. An application that only has the name of a sensor cannot gain access to that sensor without contacting the sensor registry. Thus, without knowing the sensor gateway IP address, the application cannot access data from the sensor or execute a denial of service attack on the sensor gateway. Applications with correct authentication are able to query the sensor registry and to view authorized portions of the registry.

In addition to the automatic sensor naming procedure described above, another feature of the sensor registry is application-specific naming of sensors. The sensor registry can label sensors according to application-based contexts which may have specialized meaning to one or more applications. Labels can be based on zone, location, function or capability, sensor vendor and other distinguishing contextual information.

Each application utilizing the sensor registry can add one or more application labels, or “tags”, to sensors or groups of sensors. A sensor may be associated with multiple application labels. An application label can be a shared label available for use by at least two applications. Shared labels are stored in the registry database. Alternatively, an application label can be a private label used only by a single application. Application labels enable easy access to sensor data from multiple sensors. For instance, an application might issue a single request using a label “temp” to retrieve all temperature sensor data or use a request “zone10” to obtain data from all sensors in a 10 mile radius.

Another sensor registry feature is the ability to monitor a sensor status (or “dynamic heartbeat”). Sensor status information can indicate problems due to changes in network topology, the presence of wireless interference, loss of connectivity and the like. Sensor status is determined from direct messaging or inferred by “sniffing” sensor messages that pass through the aggregation node communicating with the sensor registry. When a sensor is present online, data from the aggregation node and timestamps for the data are used to monitor the average and maximum latencies for communicating with each sensor. Examples of sensor status information are “online, 250 ms average latency, 800 ms maximum latency”, “offline, last data received 2 Jan. 2005, 15:43:55 am”, “sleep” and “unreachable, <cause>” where <cause> is a specific description for the inability to communicate with the sensor.

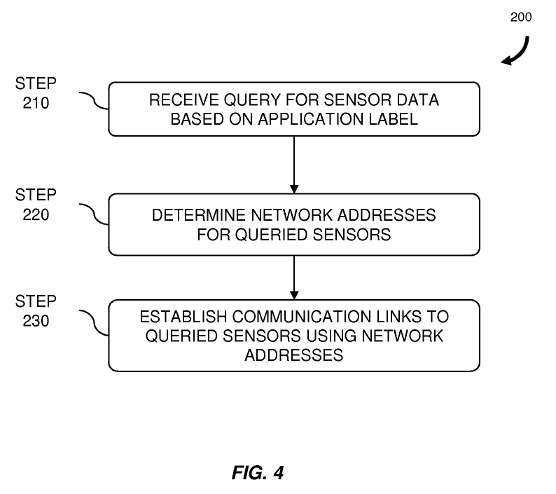

FIG. 4 is a flowchart depicting an embodiment of a method 200 for querying sensors in a sensor network in accordance with the invention. A query for sensor data is received (step 210) from an application. The query includes an application label having a context for the application. In one embodiment, the context is shared with one or more other applications on the network. A network address is determined (step 220) for each sensor associated with the application label. Sensor data are provided through communication links established (step 230) with each of the sensors associated with the application label.

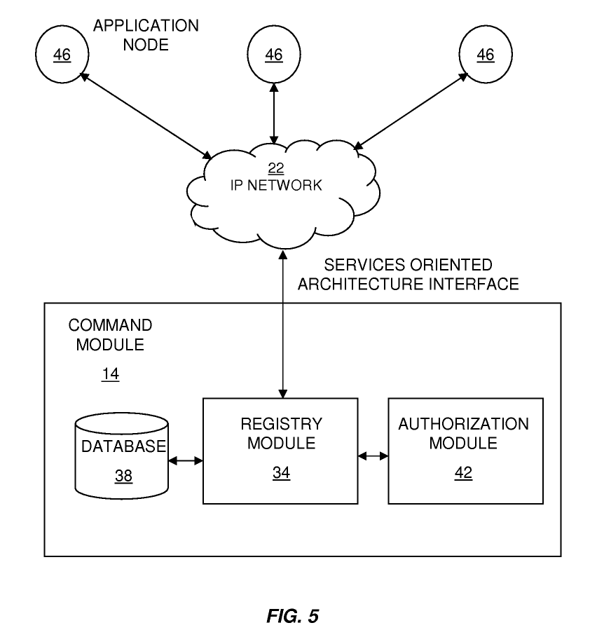

FIG. 5 depicts a hardware instantiation of a centralized sensor registry according to an embodiment of the invention. A registry module 34 communicates with a registry database 38 and an authorization module 42. The database 38 stores registry data including sensor names, sensor capabilities, IP addresses, application labels with any sharing information, sensor status information and the like. The authorization module 42 stores AAA policy information used to implement authorization procedures.

The registry module 34 also communicates with aggregation nodes to receive sensor status information and to enable communication with sensors such as sending sensor commands. Application nodes 46 communicate with the registry module to perform certain functions such as assigning application labels to sensors, defining other applications allowed to share labels, viewing sensor status data, and initiating the sending of commands to sensors.

While the invention has been shown and described with reference to specific embodiments, it should be understood by those skilled in the art that various changes in form and detail may be made therein without departing from the spirit and scope of the invention.

What is claimed is:

1. A method for registering a sensor in a sensor network, the method comprising:
detecting the presence of a sensor in communication with a network access node;
receiving information from the network access node indicating a sensor type for the sensor and a number of sensors of the sensor type that communicate with the network access node; and
automatically assigning a unique registry name to the sensor based on a name of the network access node, the sensor type and the number of sensors of the sensor type.

2. The method of claim 1 further comprising assigning an application label to the sensor to indicate a context for at least one application having access to the sensor network.

3. The method of claim 2 wherein the application label is a shared label.

4. The method of claim 1 wherein the application label is a private label.

5. The method of claim 1 further comprising storing, in a registry database, the unique registry name and an associated network address of the network access node.

6. The method of claim 1 further comprising monitoring a network aggregation node to determine a sensor status.

7. The method of claim 6 wherein the sensor status comprises at least one of an online presence, an average latency, a maximum latency, and a sensor operational mode.

8. The method of claim 1 further comprising querying a network access node upon expiration of a predetermined time to determine a sensor status.

9. The method of claim 8 wherein the sensor status comprises at least one of an online presence, an average latency, a maximum latency, and a sensor operational mode.

10. The method of claim 1 wherein the sensor is a mobile sensor.

11. The method of claim 10 further comprising:
determining a location and a reachability path of the mobile sensor; and
automatically updating the reachability path and addressing information for the mobile sensor in response to a change in the location.

12. The method of claim 11 wherein determining a location of the mobile sensor comprises receiving GPS location data.

13. The method of claim 11 wherein determining a location of the mobile sensor comprises determining an approximate location based on a current network access node for the mobile sensor.

14. A method for querying sensors in a sensor network, the method comprising:
receiving a query for sensor data from an application, the query comprising an application label having a context for at least one application having access to the sensor network;
determining a network address for each of a plurality of sensors associated with the application label; and
providing sensor data from each of the sensors associated with the application label to the application.

15. A sensor registry system for management of a sensor network, comprising:
a registry module configured to receive sensor information transmitted from a sensor gateway through the sensor network and to automatically generate a unique sensor name in response thereto, the sensor information comprising a sensor type and a network address for the sensor gateway; and
a database in communication with the registry module and configured to store the sensor type, the network address for the sensor gateway and sensor data most recently transmitted from the sensor gateway.

16. The sensor registry of claim 15 further comprising an authorization module in communication with the registry module and configured to provide access to sensor data from at least one sensor in accordance with a predetermined policy.

17. The sensor registry of claim 15 wherein the database is configured to store an application label for the sensor to indicate a context for an application having access to the sensor network.

18. The sensor registry of claim 15 wherein the database stores dynamic topology information for the sensor network.
